(19) United States
(12) Patent Application Publication
(10) Pub. No.: US 2008/0284354 A1
(43) Pub. Date: Nov. 20, 2008

(54) LIGHT EMITTING DIODE BACKLIGHT MODULE AND A DRIVING METHOD THEREOF

(75) Inventors: Li-Yi CHEN, Tainan County (TW); Ming-Chia SHIH, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/121,983

(22) Filed: May 16, 2008

(30) Foreign Application Priority Data
May 16, 2007 (TW) 96117493

(51) Int. Cl. H05B 37/02

(52) U.S. Cl. 315/294

(57) ABSTRACT

A light emitting diode (LED) backlight module includes a light emitting matrix, M row signal lines, N column signal lines, a row driver and a column driver. The light emitting matrix has multiple LED units arranged in M rows and N columns. The row driver in use outputs M row-driving signals to sequentially enable M rows of the LED units via the M row signal lines. The column driver in use sequentially outputs 1^{st} to M^{th} rows of data signals corresponding to the M row signal lines to the N columns of the LED units via the N column signal lines for generating backlight of intended luminous intensity.

This application claims the benefit of Taiwan application Serial No. 96117493, filed May 16, 2007, the subject matter of which is incorporated herein by reference in its entirety.

### BACKGROUND

1. Technical Field

The disclosure relates in general to a backlight module and a driving method thereof, and more particularly, to a light emitting diode (LED) backlight module and a driving method thereof.

2. Description of the Related Art

As the conventional LED backlight module has a uniform level of luminous intensity throughout its entire area, all portions of the backlight module have the same luminance and cannot differ from each other when displaying frames composed of portions of different brightness. For example, when a portion of frame is displaying lower brightness than the remainder of the frame, it still uses the same luminous level as the remainder of the frame, hence, wasting power. In order to save power consumption, it has been proposed to adopt multi-area locally controlled backlight which dynamically and locally controls each area of the light source to achieve the desired luminance of the entire backlight module according to the color or gray level distribution in a frame. That is, when a portion of the frame is displaying higher brightness, the backlight module locally adjusts a corresponding area of the light source to have a greater intensity of luminance, and when a portion of the frame is displaying lower brightness, the backlight module locally adjusts a corresponding area of the light source to have a lower intensity of luminance.

FIG. 1 illustrates a conventional LED backlight module. The conventional LED backlight module 10 comprises many luminous areas and a power converter 120. Each luminous area generates a desired luminous intensity by an LED unit 110. In order to locally control the luminance intensity of the different luminous areas, the conventional LED backlight module 10 adopts active matrix control, and the power converter 120 performs scanning control by many sets of channels to respectively output many sets of control signals for adjusting the luminance intensity of each corresponding LED unit 110.

For example, if the conventional LED backlight module 10 has 144 sets of the LED units 110 arranged in 9 rows and 16 columns, then the power converter 120 needs to have at least 144 sets of channels to output the control signals C(1) to C(144), respectively, for adjusting the luminance of each corresponding LED unit 110. However, if the power converter 120 needs more channels, the manufacturing cost will increase accordingly and the market competitiveness of the backlight module will be lowered.

Moreover, when the conventional LED backlight module 10 performs multi-area local backlight control, the human eyes will notice severe image faults when viewing the liquid crystal display at an oblique angle.

FIG. 2 shows Gamma curves of a liquid crystal display at a normal (front) view and at an oblique viewing angle, respectively. FIG. 3 shows a set of gray level signals, a luminous intensity distribution of corresponding backlight luminous areas, and the human eyes' vision of corresponding display regions without multi-area local backlight control. When the human eyes view the liquid crystal display illuminated by a backlight module in a normal direction, i.e., the view angle is about 0°, the correlation between light transmittances and corresponding gray levels of the vision as actually captured by human eyes is indicated in the Gamma curve 30. When the human eyes view the same liquid crystal display illuminated by the same backlight module at a 60° angle oblique from, the normal direction (i.e., at the 60° viewing angle), the correlation between light transmittances and corresponding gray levels of the vision as actually captured by human eyes is indicated in the Gamma curve 40.

If the liquid crystal display is equipped with a conventional LED backlight module 10 without multi-area local backlight control, and the luminous intensity of the luminous area 310 and the luminous area 320 are both 100%. In other words, both the luminous area 310 and the luminous area 320 are at full brightness. When gray level signals 255 and 128 are displayed in the region of the luminous area 310, the human eyes will capture a vision composed of the gray levels 255 and 128. When a gray level signal 128 is displayed in the region of the luminous area 320, the human eyes will capture a vision having the gray level 128.

FIG. 4 shows a set of gray level signals, a luminous intensity distribution of corresponding backlight luminous areas, and the human eyes' vision of corresponding display regions with multi-area local backlight control. Multi-area local backlight control is now performed so that the human eyes can still capture a vision of the intended gray level without using full brightness of the respective luminous area, thereby reducing power consumption. For example, to ensure that the human eyes can capture a vision of the intended gray level 128, the conventional LED backlight module 10 normally reduces the backlight luminous intensity in the luminous area 320 to 20% (FIG. 2) and changes the original inputted gray level signal value from 128 to 255 in order to save power consumption. When the human eyes view the liquid crystal display in a normal direction, the human eyes will still capture a vision having the intended gray level 128. Thus, the power is saved without affecting the human eyes' vision at a normal viewing angle.

FIG. 5 shows a set of gray level signals, a luminous intensity distribution of corresponding backlight luminous areas, and the human eyes' vision of corresponding display regions at a 60° viewing angle with multi-area local backlight control. As shown in FIG. 2, the Gamma curve 30 when the frame is viewed in the normal direction is different from the Gamma curve 40 when the frame is viewed at an oblique angle. Therefore, when the luminous area 320, whose backlight luminous intensity percentage is locally adjusted to be 20% as discussed above with respect to FIG. 4, and the original inputted gray level signal value is changed from 128 to 255 in order to save power consumption, the human eyes will sense a vision having the unintended gray level 45 (FIG. 2) when viewing the liquid crystal display at an oblique angle.

Furthermore, when the human eyes view the liquid crystal display in a normal direction, the human eyes see both the luminous areas 310 and 320 as having the gray level 128 (FIG. 4). When the human eyes view the liquid crystal display at an oblique viewing angle of, e.g., 60°, the human eyes see the luminous area 310 and the luminous area 320 as having different gray levels (FIG. 5), i.e., at 128 and 45, respectively. Due to such significant differences, the frame data originally having the same gray level (128) will be incorrectly seen as having different gray levels as an image fault when displayed by backlight areas having different luminous intensities.

Thus, if the conventional LED backlight module 10 performs multi-area local backlight control, the vision varies and depends on whether the human eyes view the liquid crystal display in a normal direction or at an oblique angle, hence, incurring poor display quality of the liquid crystal display.

### SUMMARY

According to a first aspect, an LED backlight module comprises a light emitting matrix, M row signal lines, N column signal lines, a row driver and a column driver. The light emitting matrix comprises a plurality of LED units arranged in M rows and N columns. The row driver is configured for outputting M row-driving signals via the corresponding M row signal lines to sequentially enable M rows of the LED units. The column driver is configured for sequentially outputting 1^{st} to M^{th} rows of data signals corresponding to the M row signal lines to the N columns of the LED units via the N column signal lines for generating backlight of intended luminous intensity.

In a further aspect, a method of driving an LED backlight module, wherein the LED backlight module comprises a light emitting matrix comprising a plurality of LED units arranged in a matrix having M rows and N columns, comprises: (a) outputting M row-driving signals, during a frame, to sequentially enable the M rows of the LED units via M row signal lines, respectively; and (b) sequentially outputting, during said frame, the 1^{st} to M^{th} rows of data signals, each of which respectively corresponds to one of the M row signal lines to the LED units via N column signal lines.

Additional aspects and advantages of the disclosed embodiments are set forth in part in the description which follows, and in part are apparent from the description, or may be learned by practice of the disclosed embodiments. The aspects and advantages of the disclosed embodiments may also be realized and attained by means of the instrumentalities and combinations particularly pointed out in the appended claims.

### BRIEF DESCRIPTION OF THE DRAWINGS

The accompanying drawings are included to provide a further understanding of embodiments of the invention, and are incorporated in and constitute a part of this specification.

FIG. 1 (Prior Art) illustrates a conventional LED backlight module;

FIG. 2 (Prior Art) shows Gamma curves of a liquid crystal display at a normal view and at an oblique viewing angle, respectively;

FIG. 3 (Prior Art) shows a set of gray level signals, a luminous intensity distribution of corresponding backlight luminous areas, and the human eyes' vision of corresponding display regions without multi-area local backlight control;

FIG. 4 (Prior Art) shows a set of gray level signals, a luminous intensity distribution of corresponding backlight luminous areas, and the human eyes' vision of corresponding display regions when multi-area local backlight control is performed;

FIG. 5 (Prior Art) shows a set of gray level signals, a luminous intensity distribution of corresponding backlight luminous areas, and the human eyes' vision of corresponding display regions at a 60° viewing angle with multi-area local backlight control;

FIG. 6 shows an LED backlight module according to an embodiment of the invention;

FIG. 7 shows a first time diagram of scanning signals and luminous data;

FIG. 8 shows the first time diagram, of scanning signals and luminous data when M equals 9;

FIG. 9 is a time table of FIG. 8;

FIG. 10 shows a second time diagram of scanning signals and luminous data;

FIG. 11 shows the second time diagram of scanning signals and luminous data when M equals 9 and I equals 3;

FIG. 12 is a time table of FIG. 11.

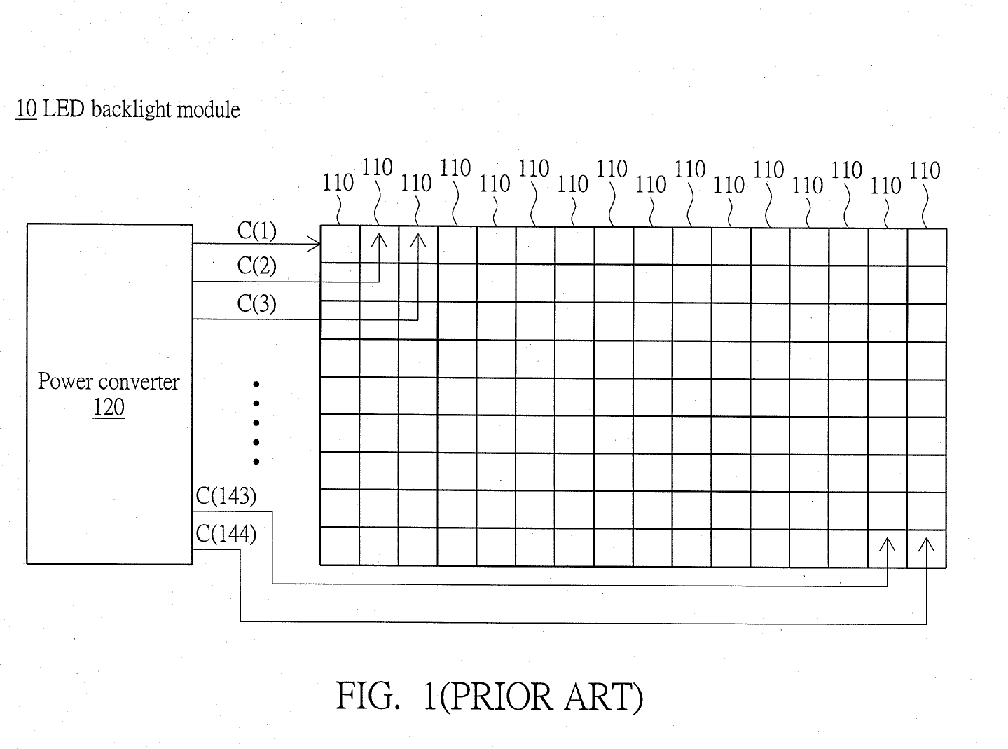

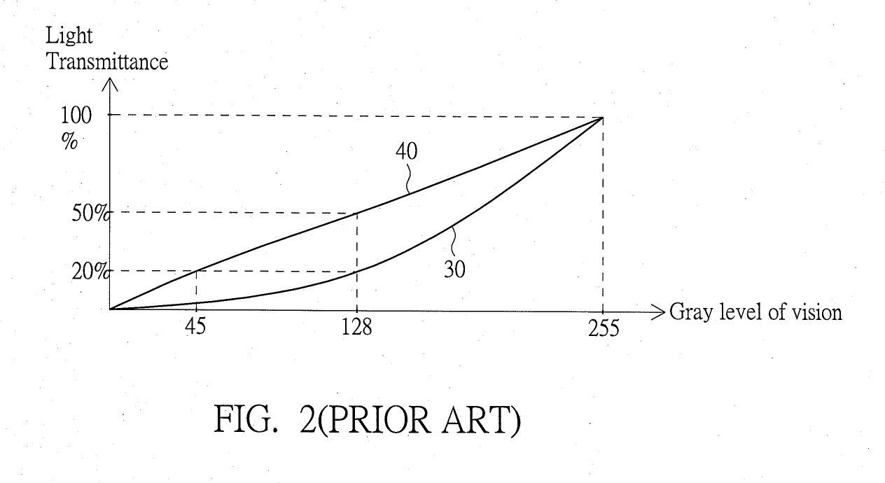

### DETAILED DESCRIPTION OF EMBODIMENTS OF THE INVENTION

Reference will now be made in detail to the present embodiments of the invention, examples of which are illustrated in the accompanying drawings. Wherever possible, the same reference numbers are used in the drawings and the description to refer to the same or like parts.

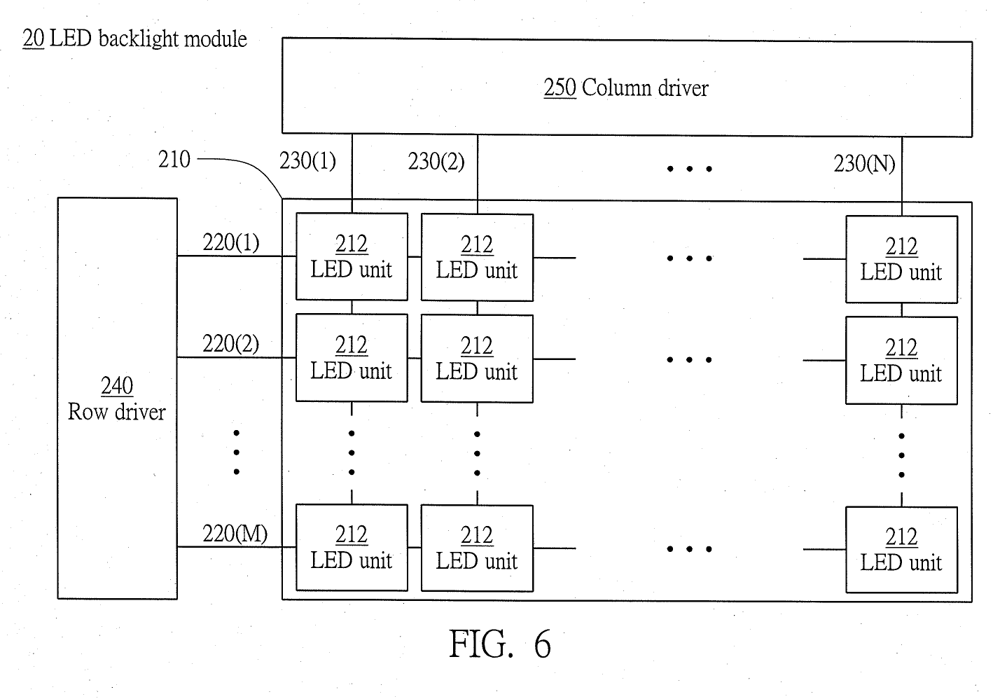

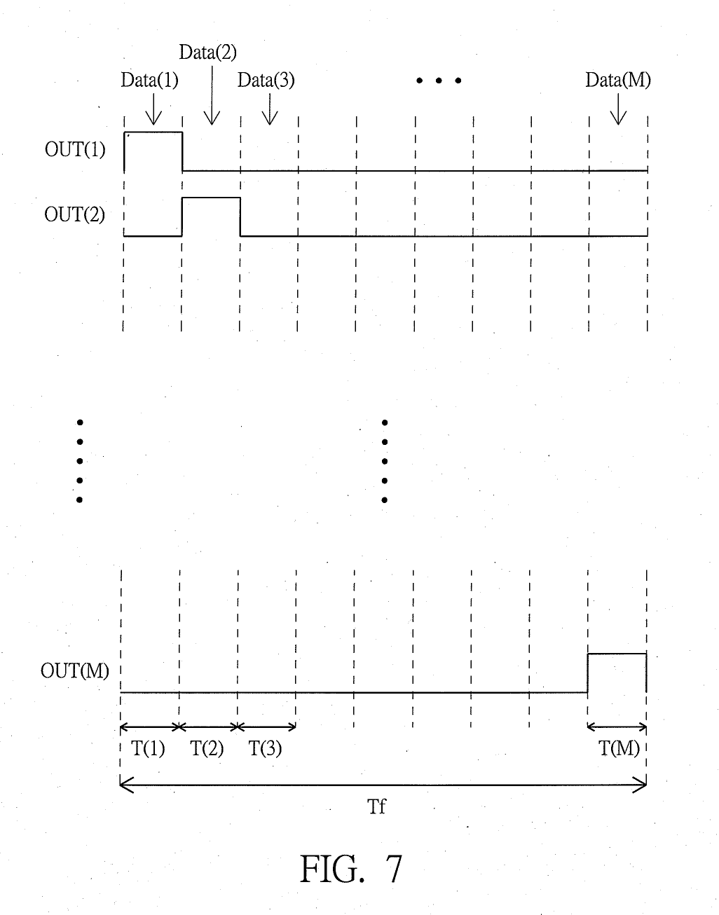

Referring to FIG. 6, a light emitting diode (LED) backlight module according to an embodiment of the invention is shown. The LED backlight module 20, such as a passive matrix backlight module, comprises a light emitting matrix 210, M row signal lines 220(1) to 220(M), N column signal lines 230(1) to 230(N), a row driver 240 and a column driver 250. The light emitting matrix 210 comprises many LED units 212 corresponding to different luminous areas, wherein LED units 212 are arranged in M rows and N columns and each of LED units 212 includes one light emitting diode (LED) or many serially connected LEDs, and each LED unit 212 can selectively include a capacitor to increase the illuminating time.

The row driver 240 is coupled to M rows of the LED units 212 via the row signal lines 220(1) to 220(M), and the column driver 250 is coupled to the N columns of the LED units 212 via the N column signal lines 230. The row driver 240 can sequentially enable the 1^{st} to M^{th} rows of the LED units 212 in a frame time. That is, the row driver 240 sequentially inputs a voltage whose level is sufficient for enabling the LED units 212 to form an operational voltage or an operational current. The column driver 250 sequentially outputs 1^{st} row to M^{th} row of data signals corresponding to the row signal lines 220(1) to 220(M) via the N column signal lines 230 for generating corresponding luminous intensity. In this particular embodiment, multi-area local backlight control is performed, and hence, the data signals outputted by the column driver 250 are the locally adjusted gray level signals as exemplarily explained with respect to FIG. 4.

First time diagram of row driving signals and data signals

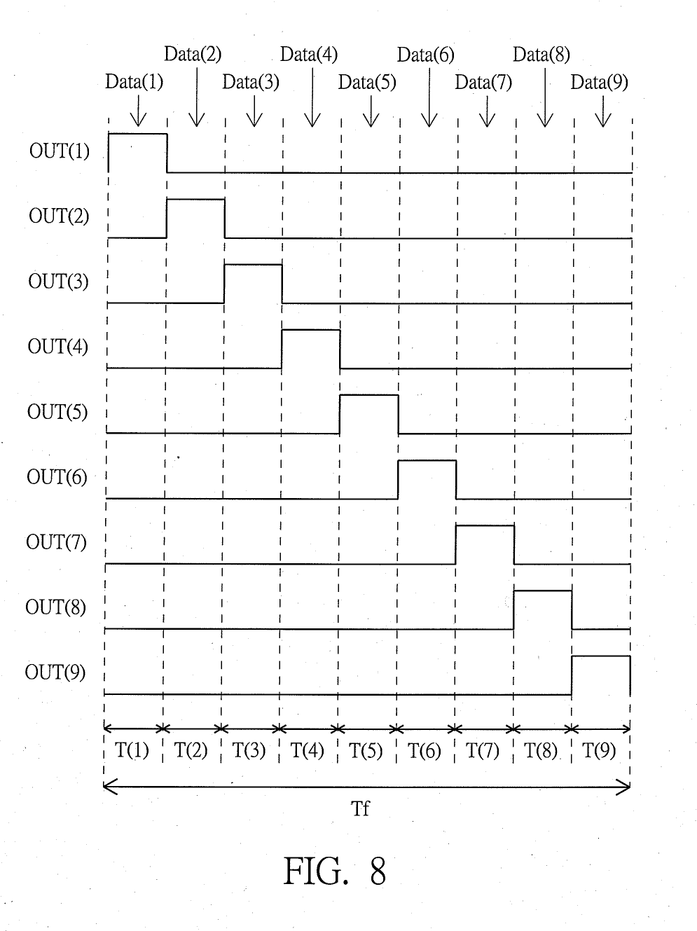

Referring to FIG. 7, a first time diagram of scanning signals (row driving signals) and luminous data (data signals) is shown. The row driver 240 outputs M row driving signals OUT(1) to OUT(M) in a frame time T_{f}. The M row driving signals OUT(1) to OUT(M) sequentially enable the 1^{st} to M^{th} rows of the LED units 212 via the M row signal lines 220(1) to 220(M), respectively. The column driver 250 sequentially outputs each row of data (Data(1) to Data(M)) respectively corresponding to the 1^{st} to M^{th} row signal lines 220.

The M row driving signals OUT(1) to OUT(M) are not at the enabling level simultaneously, and the duty cycle of each of the M row driving signal

$$OUT ( 1 ) to OUT ( M ) is \frac{1}{M} ,$$

so that the enabling time of each of the M row driving signals

$$OUT ( 1 ) to OUT ( M ) is \frac{{T}_{f}}{M} .$$

The frame time T_{f} is divided into M time periods T(1) to T(M) with equal length of duration, and the time periods T(1) to T(M) are respectively

$$\frac{{T}_{f}}{M} .$$

The column driver 250 outputs a first row of data (Data(1)) in the time period T(1) via the N column signal lines, and outputs a second row of data (Data(2)) in the time period T(2) via the N column signal lines. Similarly, the column driver 250 correspondingly outputs a third row of data (Data(3)) through a M^{th} row of data (Data(M)) in the time period T(3) through the time period T(M), respectively. That is, a k^{th} row of data (Data(k)) is outputted in the time period T(k) via the N column signal lines.

The 1^{st} to M^{th} rows of the LED units 212 are sequentially enabled for generating corresponding luminous intensity, so that the LED backlight module 20 will generate a multi-area local backlight control effect of scanning backlight to improve the display quality of dynamic images.

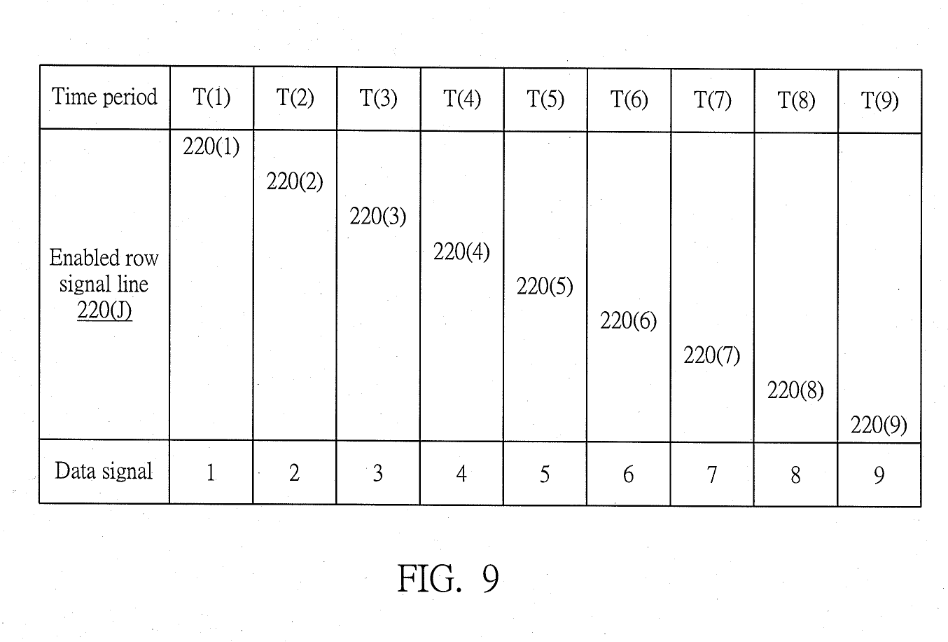

FIG. 8 shows a first time diagram of scanning signal and luminous data when M equals 9. FIG. 9 is a time table of FIG. 8. In order to make this particular example of the embodiment easier to understand, M is exemplified as 9 in the following disclosure. However, the invention is not limited thereto and M can be adjusted to fit actual needs.

When the number of the row signal lines 220 equals 9, the row driver 240 outputs 9 row driving signals OUT(1) to OUT(9) in a frame time T_{f}, wherein the row driving signals OUT(1) to OUT(9) sequentially enable the 1^{st} to the 9^{th} rows of the LED units 212 via the row signal lines 220(1) to 220(9), respectively. The column driver 250 sequentially outputs the 9 rows of data (Data(1) to Data(9)) respectively corresponding to the row signal lines 220(1) to 220(9).

The row driving signals OUT(1) to OUT(9) are not at the enabling level simultaneously, and the duty cycle of each of the row driving signals

$$OUT ( 1 ) to OUT ( 9 ) is \frac{1}{9} ,$$

so that the enabling time of each of the row driving signals

$$OUT ( 1 ) to OUT ( 9 ) is \frac{{T}_{f}}{9} .$$

The frame time T_{f} is divided into 9 time periods T(1) to T(9) with an equal length of duration, and the time periods T(1) to T(9) are respectively

$$\frac{{T}_{f}}{9} .$$

The column driver 250 outputs a first row of data (Data(1)) via the N column signal lines in time period T(1), and outputs a second row of data (Data(2)) via the N column signal lines in time period T(2). Similarly, the column driver 250 correspondingly outputs a 3^{rd} row of data (Data(3)) through a 9^{th} row of data (Data(9)) in the time period T(3) through the time period T(9), respectively. For example, when N equals 16, the column driver 250 outputs each row of data respectively in a corresponding time period via the column signal lines 230(1) to 230(16).

The 1^{st} to the 9^{th} rows of the LED units 212 are sequentially enabled for generating corresponding luminous intensity, so that the LED backlight module 20 can perform multi-area local backlight control to save power consumption as well as lower the circuit complexity and reduce the manufacturing cost.

Second time diagram of row driving signals and data signals

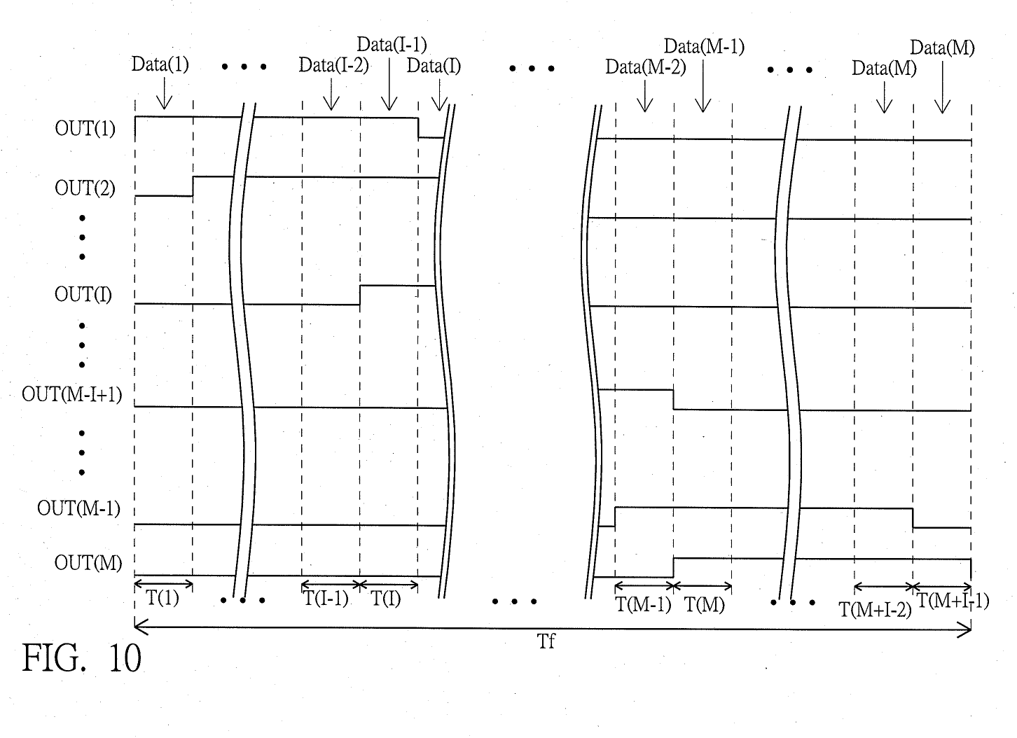

In the first embodiment, the average luminance of the backlight module 20 in frame time T_{f} is 1/M as in the multi-area local backlight module. Referring to FIG. 10, a second time diagram of scanning signals (row driving signals) and luminous data(data signals) is shown. Moreover, the row driver 240 can also increase the enabling time for the row driving signals OUT(1) to OUT(M) respectively, and partly overlap the enabling time of neighboring row driving signals so as to further increase the backlight luminous intensity of the LED backlight module 20.

The frame time T_{f} is divided into (M+I−1) time periods with an equal length of duration. The (M+I−1) time periods sequentially are time periods T(1) to T(I−1), time periods T(l) to T(M), and time periods T(M+1) to T(M+I−1), wherein I is the number of rows of the LED units that are simultaneously enabled within a time period among the time periods T(I) to T(M). In each of the time periods T(1) to T(I−1) and each of the time periods T(M+1) to T(M+I−1), the number of rows of the LED units that are simultaneously enabled within a time period is smaller than I.

The duty cycle of each of the row driving signal

$$OUT ( 1 ) to OUT ( M ) is \frac{I}{M + I - 1} ,$$

so that the enabling time of each of the row driving signals

$$OUT ( 1 ) to OUT ( M ) is \frac{I \times {T}_{f}}{M + I - 1} .$$

The column driver 250 outputs a first row of data (Data(1)) during time periods T(1), and correspondingly outputs (I−2) rows of data(Data(1)˜Data(I−2)) sequentially during time periods T(2) to T(I−1) via the N column signal lines, and correspondingly outputs (M−I+1) rows of data (Data(I−1) to Data(M−1)) sequentially during time periods T(1) to T(M) via the N column signal lines, and correspondingly outputs (I-2) rows of data(Data(M−I+3)-Data(M)) sequentially during time periods T(M+1) to T(M+I−2) via the N column signal lines, and outputs a M^{th} row of data (Data(M)) during the time periods T(M+I−1) via the N column signal lines.

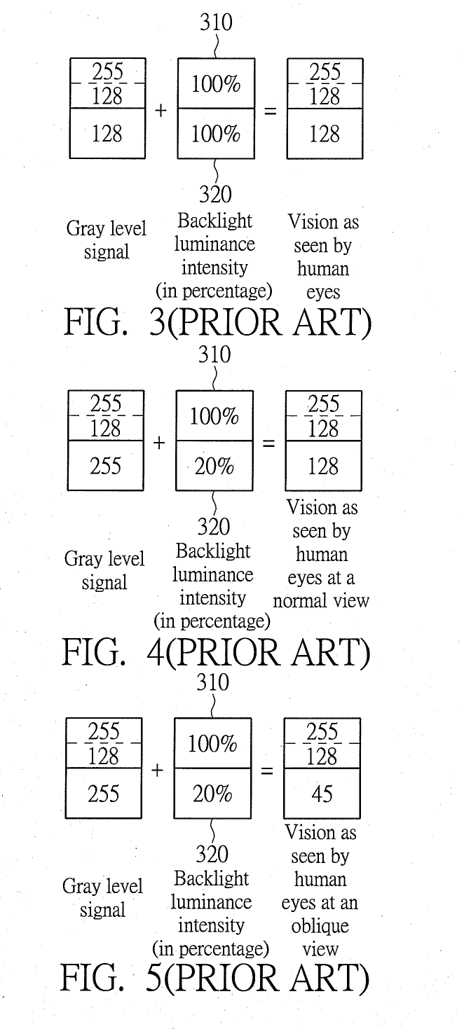

According to the above disclosure, except for time periods T(1) and T(M+I−1), the row driver 240 enables at least 2 rows of LED units 212 within each time period. Compared with the embodiment of FIG. 7 in which only one row be enabled within each time period, this second embodiment can further improve the backlight luminous intensity. Besides, the row driver 240 is capable of enabling 2 to I rows of the LED units 212 within each time period. Therefore, under multi-area local backlight control, despite that luminous intensity may differs significantly between each row of the LED units 212, the human eyes will still feel smooth variation in luminous intensity, so that the vision of images on the liquid crystal display in an oblique view is more consistently with the vision in a normal view than the prior art disclosed in FIG. 4 and FIG. 5. More particularly, the image fault at an oblique view in the conventional LCD resulted from a gray level difference between two adjacent backlight areas, e.g., 310 and 320 in FIGS. 4-5. The image fault further resulted from the conspicuous drop or rise of backlight luminous intensity between the two adjacent backlight areas. However, in this embodiment, when the backlight area 310 needs to use 100% backlight luminous intensity and is turned on, the adjacent backlight area 320 also uses 100% backlight luminous intensity and is turned on simultaneously. In the subsequent duration period when the backlight area 320 uses 20% backlight luminous intensity and is turned on, the adjacent backlight area 310 also uses 20% backlight luminous intensity and is turned on simultaneously. Therefore, the difference in luminous intensity between the two adjacent areas will be eliminated.

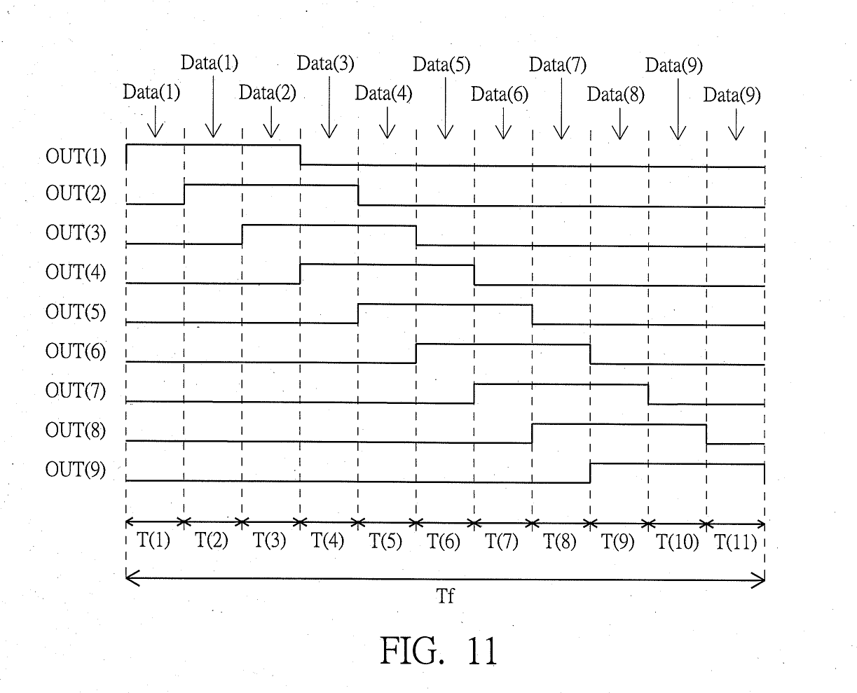

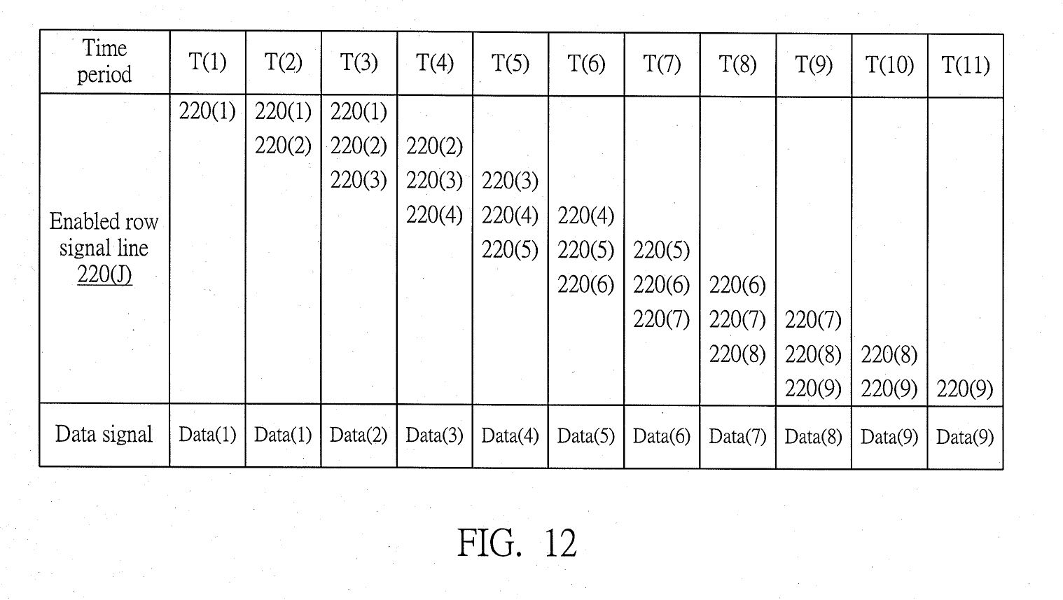

FIG. 11 shows a second time diagram of scanning signal and luminous data when M equals 9 and 1 equals 3. FIG. 12 shows a time table of FIG. 11. In order to make this particular example of the embodiment easier to understand, M and I are respectively exemplified as 9 and 3 in the following disclosure. However, the invention is not limited thereto and M and I can be adjusted to fit actual needs.

When the number of the row signal lines 220 is 9, the row driver 240 outputs 9 row driving signals OUT(1) to OUT(9) in a frame time T_{f}, the duty cycle of each of the row driving signals

$$OUT ( 1 ) to OUT ( M ) is \frac{3}{11} ,$$

so that the enabling time of each of the row driving signals

$$OUT ( 1 ) to OUT ( M ) is \frac{3 \times {T}_{f}}{11} .$$

The row driving signals OUT(1) to OUT(9) sequentially enable the 1^{st} to the 9^{th} row of LED units 212 via the row signal lines 220(1) to 220(9), respectively. The column driver 250 sequentially outputs 9 sets of the row data, i.e., Data(1) to Data(9), corresponding to the row signal lines 220(1) to 220(9), respectively.

The frame time T_{f} is divided into 11 time periods T(1) to T(11) with an equal length of duration. The row driver 240 enables the 1^{st} row of the LED units 212 in time period T(1), and enables the 1^{st} and 2^{nd} rows of the LED units 212 in time period T(2).

The row driver 240 enables the 1^{st} to the 3^{rd} rows of the LED units 212 in time period T(3), and enables the 2^{nd} to the 4^{th} rows of the LED units 212 in time period T(4). Similarly, during time periods T(3) to T(9), the row driver 240 enables the (k−2)^{th}, the (k−1)^{th} and the k^{th} rows of the LED units 212 in time period T(k), k=3 to 9.

Afterwards, the row driver 240 enables the 8^{th} and the 9^{th} rows of the LED units 212 in time period T(10), and enables the 9^{th} row of the LED units 212 in time period T(11).

The column driver 250 outputs 1^{st} row of data, i.e., Data(1), during the time periods T(1) to T(2) via the N column signal lines, sequentially outputs 7 rows of data, i.e., Data(2) to Data(8), each during one of the time periods T(3) to T(9), and outputs the 9^{th} row of data, i.e., Data(9), during the time periods T(10) to T(11). For example, when the 1^{st}, the 2^{nd} and the 3^{rd} rows of the LED units 212 are enabled in the time period T(3), the column driver 250 outputs the 2^{nd} row of data, i.e., Data(2); when the 2^{nd}, the 3^{rd} and the 4^{th} rows of the LED units 212 are enabled in time period T(4), the column driver 250 outputs the 3^{rd} row of data, i.e., Data(3), and so on.

Except time periods T(1) and T(11), the row driver 240 enables at least 2 rows of the LED units 212 within each time period. Therefore, the LED backlight module 20 is capable of increasing backlight luminous intensity. Moreover, the row driver 240 mostly enables 3 rows of the LED units 212 within a time period, so the human eyes will still feel smooth variation in luminous intensity, so that the vision of images on the liquid crystal display in an oblique view is more consistently with the vision in a normal view.

The LED backlight module and the driving method thereof disclosed in the above embodiments of the invention not only reduce the manufacturing cost of the LED backlight module but also improve image quality of the liquid crystal display viewed at an oblique viewing angle when multi-area dynamic backlight control is performed.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting diode (LED) backlight module, comprising:
a light emitting matrix comprising a plurality of LED units arranged in a matrix having M rows and N columns;
M row signal lines;
N column signal lines;
a row driver for outputting, during a frame, M row-driving signals to sequentially enable the M rows of the LED units via the M row signal lines; and
a column driver for sequentially outputting, during said frame, 1^{st} to M^{th} rows of data signals, each of which respectively corresponds to one the M row signal lines, to the N columns of the LED units via the N column signal lines for generating backlight of intended luminous intensity.

2. The backlight module according to claim 1, wherein the row driver is configured for preventing any two of the M row-driving signals from being at an enabling level simultaneously.

3. The backlight module according to claim 1, wherein the row driver is configured to sequentially enable the M rows of the LED units in said frame divided into 1^{st} to M^{th} time periods with an equal length of duration.

4. The backlight module according to claim 3, wherein the column driver is configured to output the 1^{st} to M^{th} rows of data signals to the LED units in the 1^{st} to M^{th} time periods, respectively.

5. The backlight module according to claim 1, wherein the M row-driving signals comprise a J^{th} row-driving signal and a (J+1)^{th} row-driving signal, wherein the (J+1)^{th} row is adjacent to the J^{th} row, and the enabling time of the J^{th} row driving signal partly overlaps with that of the (J+1)^{th} row driving signal, whereby the LED units in the (J+1)^{th} row and the J row are simultaneously enabled during said overlapping time.

6. The backlight module according to claim 5, wherein the row driver is configured to sequentially enable the M rows of the LED units in said frame divided into (M+I−1) time periods with an equal length of duration, the (M+I−1) time periods comprise a 1^{st} to an (I−1)^{th} time periods, an I^{th} to an M^{th} time periods and an (M+1)^{th} to an (M+I−1)^{th} time periods, I is the number of rows of the LED units enabled within a time period among the I^{th} time period to the M^{th} time period.

7. The backlight module according to claim 6, wherein the number of rows of the LED units enabled within a time period among the 1^{st} time period to the (I−1)^{th} time period is smaller than 1.

8. The backlight module according to claim 6, wherein the number of rows of the LED units enabled in the same time period during the (M+1)^{th} time period to the (M+I−1)^{th} time period is smaller I.

9. The backlight module according to claim 6, wherein the column driver is configured for:
outputting the first row of data signals in the 1^{st} time period via the N column signal lines,
respectively outputting the 1st row of data signals to the (I−2)^{th} row of data signals sequentially in the corresponding 2^{nd} time period to (I−1)^{th} time period via the N column signal lines;
respectively outputting the (I−1)^{th} row of data signals to the (M−1)^{th} row of data signals sequentially in the corresponding I^{th} time period to M^{th} time period via the N column signal lines,
respectively outputting the (M−I+3)^{th} row of data signals to the M^{th} row of data signals sequentially in the corresponding (M+1)^{th} time period to (M+I−2)^{th} time period via the N column signal lines; and
outputting the M^{th} row of data signals in the (M+I−1)^{th} time period via the N column signal lines.

10. The backlight module according to claim 1, wherein
the row driver is configured to simultaneously enable at least two adjacent rows of the LED units; and
the column driver configured to output a same row of data signals to the at least two adjacent rows of the LED units.

11. A method of driving an LED backlight module, wherein the LED backlight module comprises a light emitting matrix comprising a plurality of LED units arranged in a matrix having M rows and N columns, the driving method comprising:
(a) outputting M row-driving signals, during a frame, to sequentially enable the M rows of the LED units via M row signal lines, respectively; and
(b) sequentially outputting, during said frame, the 1^{st} to M^{th} rows of data signals, each of which respectively corresponds to one of the M row signal lines to the LED units via N column signal lines.

12. The driving method according to claim 11, wherein in the step (a), any two of the M row-driving signals are not at an enabling level simultaneously.

13. The driving method according to claim 11, wherein in the step (a), the M rows of the LED units are sequentially enabled in said frame divided into 1^{st} to M^{th} time periods with an equal length of duration.

14. The driving method according to claim 13, wherein in the step (b), the 1^{st} to M^{th} rows of data signals are respectively outputted to the LED units in the 1^{st} to M^{th} time periods.

15. The driving method according to claim 11, wherein in the step (a), the M row-driving signals comprise a J^{th} row-driving signal and a (J+1)^{th} row-driving signal, wherein the (J+1)^{th} row is adjacent to the J^{th} row, and the enabling time of the J^{th} row driving signal partly overlaps with that of the (J+1)^{th} row driving signal, whereby the LED units in the (J+1)^{th} row and the J^{th} row are simultaneously enabled during said overlapping time.

16. The driving method according to claim 15, wherein in the step (a), the M rows of the LED units are sequentially enabled in said frame divided into (M+I−1) time periods with an equal length of duration, the (M+I−1) time periods comprise a 1^{st} to an (I−−1)^{th} time periods, an I^{th} to an M^{th} time periods and an (M+1)^{th} to an (M+I−1)^{th} time periods, I is the number of rows of the LED units enabled within a time period among the I^{th} time period to the M^{th} time period.

17. The driving method according to claim 16, wherein in the step (a), the number of rows of the LED units enabled within a time period among the 1^{st} time period to the (I−1)^{th} time period is smaller than 1.

18. The driving method according to claim 16, wherein in the step (a), the number of rows of the LED units enabled in the same time period during the (M+1)^{th} time period to the (M+I−1)^{th} time period is smaller than I.

19. The driving method according to claim 16, wherein the step (b) comprises:
(b1) outputting the first row of data signals in the 1^{st} time period via the N column signal lines,
(b2) respectively outputting the 1^{st} row of data signals to the (I−2)^{th} row of data signals sequentially in the corresponding 2^{nd} time period to (I−1)^{th} time period via the N column signal lines;
(b3) respectively outputting the (I−1)^{th} row of data signals to the (M−1)^{th} row of data signals sequentially in the corresponding I^{th} time period to M^{th} time period via the N column signal lines,
(b4) respectively outputting the (M−I+3)^{th} row of data signals to the M^{th} row of data signals sequentially in the corresponding (M+1)^{th} time period to (M+I−2)^{th} time period via the N column signal lines; and
(b5) outputting the M^{th} row of data signals in the (M+I−1)^{th} time period via the N column signal lines.

20. The driving method according to claim 11, wherein
in the step (a), at least two adjacent rows of the LED units are simultaneously enabled; and
in the step (b), a same row of data signals is outputted to the at least two adjacent rows of the LED units.
